(19) United States
(12) Patent Application Publication
(10) Pub. No.: US 2014/0287389 A1
(43) Pub. Date: Sep. 25, 2014

(54) SYSTEMS AND METHODS FOR REAL-TIME ADAPTIVE THERAPY AND REHABILITATION

(71) Applicant: THE REGENTS OF THE UNIVERSITY OF CALIFORNIA, Oakland, CA (US)

(72) Inventors: Marcelo Kallmann, Merced, CA (US); Carlo Camporesi, Merced, CA (US); Jay Han, Folsom, CA (US)

(73) Assignee: THE REGENTS OF THE UNIVERSITY OF CALIFORNIA, Oakland, CA (US)

(21) Appl. No.: 14/214,483

(22) Filed: Mar. 14, 2014

Related U.S. Application Data
(60) Provisional application No. 61/782,776, filed on Mar. 14, 2013.

(51) Int. Cl. G06F 19/00

(52) U.S. Cl. CPC G06F 19/3481
USPC 434/247

(57) ABSTRACT

Virtual reality-based adaptive systems and methods are disclosed for improving the delivery of physical therapy and rehabilitation. The invention comprises an interactive software solution for tracking, monitoring and logging user performance wherever sensor capability is present. To provide therapists with the ability to observe and analyze different motion characteristics from the exercises performed by patients, novel visualization techniques are provided for specific solutions. These visualization techniques include color-coded therapist-customized visualization features for motion analysis.

### CROSS-REFERENCE TO RELATED APPLICATIONS

This application claims the benefit of U.S. provisional patent application Ser. No. 61/782,776 filed on Mar. 14, 2013, incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to systems and methods for computer-aided physical therapy and rehabilitation, and more particularly to systems and methods for virtual physical therapy and rehabilitation.

2. Description of Related Art

Rehabilitation and physical therapy are optimal when assessment, monitoring, adherence to the therapy program and patient engagement can be achieved. With recent technical advances developed in Virtual Reality (VR), innovative approaches to improve traditional physical therapy and rehabilitation practice can be explored.

Different processes are involved with physical therapy: physical examination, evaluation, assessment, therapy intervention, monitoring, and modification of the therapy program according to patient recovery. In traditional physical therapy, after a preliminary step of diagnostic and quantitative measurements, a patient is guided by a trained therapist to perform specific therapeutic exercises correctly. The tasks performed are designed according to the recovery plan and imply repetitions where the therapist needs to evaluate the exercise both qualitatively and quantitatively.

This process is usually intensive, time consuming, dependent on the expertise of the therapist, and implies collaboration of the patient who is usually asked to perform the therapy multiple times at home with no supervision. At the same time, patients often perceive the tasks as repetitive and non-engaging, consequently reducing the patient's level of involvement.

Currently, some existing products utilize gaming interface and environment for therapy. However, these lack sophistication and personalization of therapy that's provided by individualized therapy sessions.

Commercial software solutions are available for improving physical therapy. However, the exercises offered to the patients are still mostly limited to descriptions on paper and/or explanatory videos. No patient interaction or logging has been available.

Previous works have applied VR/Imaging solutions to provide rehabilitation to patients with stroke. The use of exoskeletons and robotic arms with force feedback have also been employed for assisting impaired patients, however, these involve cumbersome and costly devices not very suitable for widespread adoption. Solutions for tracking the motions of patients and for encouraging user engagement have also been explored; however, they are not integrated within therapy programs with customized exercises and real-time feedback and logging. With a different purpose, fitness applications have also emerged from videogame interfaces and other custom-made light devices.

Accordingly, an object of the present invention is a VR-based integrated system that addresses several current difficulties. At least some of these objects will be met in the description below.

### BRIEF SUMMARY OF THE INVENTION

The present invention is a system and method based on virtual reality technologies for improving the delivery of physical therapy and rehabilitation. In one embodiment, the invention comprises an interactive software solution for tracking, monitoring and logging user performance wherever sensor capability is present. To provide therapists with the ability to observe and analyze different motion characteristics from the exercises performed by patients, novel visualization techniques are provided for specific solutions. These visualization techniques include color-coded therapist-customized visualization features for motion analysis, and the frequency map ROM representation. The disclosed therapy is networked collaborative remote therapy via connected application and provides customized adaptive delivery of exercises.

Aspects of the invention include, but are not limited to: 1) interactive software framework for physical therapy containing: a) a high-end Immersive virtual reality configuration, and b) an inexpensive setup/a low-cost configuration (e.g. based on Kinect solutions); 2) a virtual reality based system including: a) customized therapy exercises and exercise programs for individual patients, b) automatic therapy/virtual exercise delivery and monitoring, and c) networked collaborative remote therapy via a connected application; 3) a software solution for tracking, monitoring and logging exercise performance; 4) novel visualization techniques including: a) a color-coded therapist-customized visualization features for motion analysis; b) frequency map ROM representations of specific articulations; 5) customized adaptive delivery of exercises including: a) Autonomous adaptation; and b) personal therapists for each patient; 6) modes of adaptation including: a) speed adaptation, b) amplitude adaptation, and c) repetition enforcement; 7) real-time collaboration at home or clinical settings where patients can perform exercises with real time feedback from the therapist; 8) use of 3D assessment tools and 3D virtual avatars that allow patients and therapists to interact between each other intuitively; 9) use of an automatic motion detection mechanism; 10) use of an autonomous virtual tutor; and 11) an offline mode (with no direct interaction between the therapist and patient).

The system allows therapists to model personalized exercises by demonstration and thus can customize exercises for a specific patient and match their needs. Libraries of exercises can be developed for effective reuse in new therapy programs. Therapy programs can be performed by a virtual character demonstrating exercises step by step, including monitoring and logging patient execution. Monitoring and progress tracking improves patient understanding, motivation and compliance, and also provides data gathering. Finally, the system also allows simultaneous networked sessions between remote patients and therapists sharing motion performances in real-time. The transmitted data is lightweight and remote collaboration can be scaled up to several patients at the same time. The system also provides 3D assessment tools for monitoring the range of motion, and for allowing the visualization of a number of therapy parameters during or after execution of exercises. The system can be implemented in both low-cost and high-end configurations.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic diagram of a real-time adaptive virtual rehabilitation system in accordance with the present invention.

FIG. 2 shows a screen view embodying the main interface for the application software of FIG. 1.

FIG. 3 illustrates a sensor tracking window that displays a stylized character made of lines illustrative of the anatomy of the user being tracked by the sensor.

FIG. 4 illustrates a window showing a basic patient interface in accordance with the present invention.

FIG. 5A and FIG. 5B show windows for a demonstration phase interface in accordance with the preset invention.

FIG. 6 illustrates a window for exercise templates interface in accordance with the preset invention.

FIG. 7 shows a window of a therapy program panel that allows the therapist to create customized therapy programs tailored for specific patients.

FIG. 8 shows parameterization and adaption window, which allows the virtual therapist to adapt exercises to the user's performances.

FIG. 9A through 9D show images of trajectory trails of an avatar though a shoulder flexion exercise of a patient's right arm at various angles.

FIG. 10 shows an image of an avatar and 3D arrows for illustrating the distance between corresponding pairs of joints (e.g. 152A and 152B).

FIG. 11 shows an image of a range of motion frequency map.

FIG. 12 shows a diagram of blending operations in accordance with the present invention.

### DETAILED DESCRIPTION OF THE INVENTION

A. System Overview

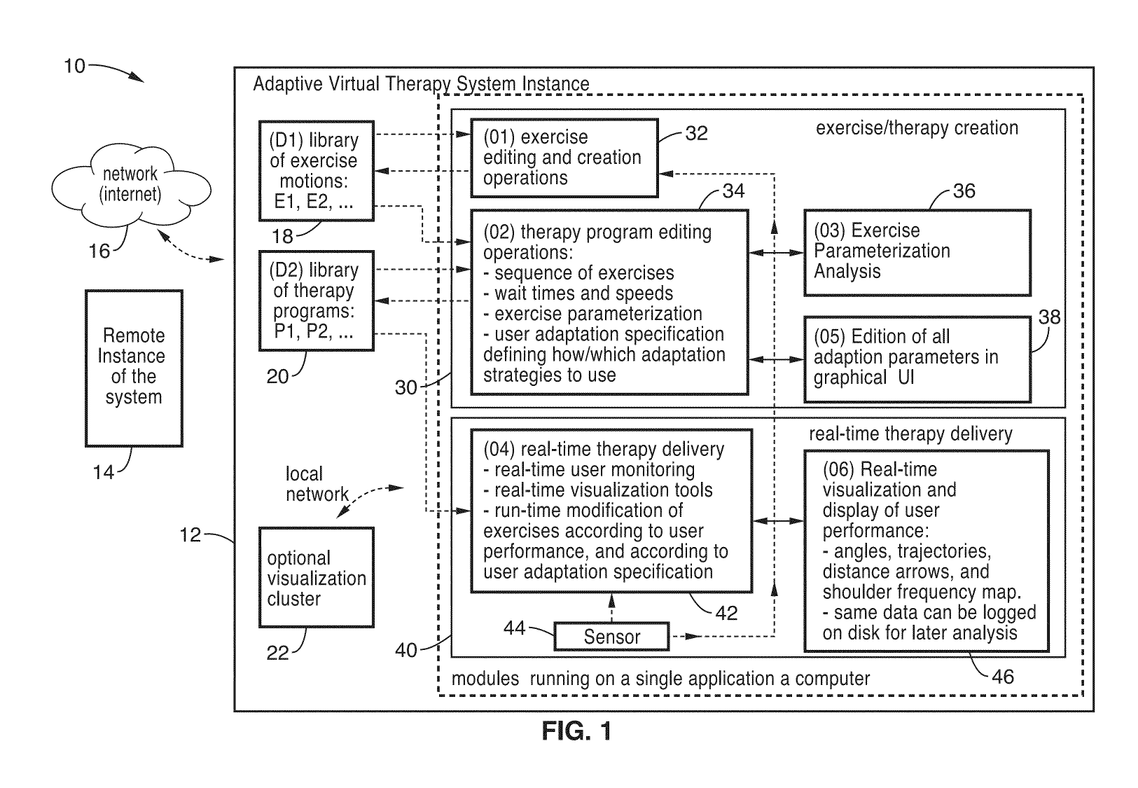

FIG. 1 is a schematic diagram of a real-time adaptive virtual rehabilitation system 10 in accordance with the present invention. FIG. 1 illustrates an adaptive virtual therapy system instance 12 that is configured to communicate with one or more users over network or Internet 16 with other remote instances 14.

The system 10 includes a plurality of databases (e.g. library of exercise motions 18 and library of therapy programs 20) that may store generated exercises and therapy programs for use by therapist and patient instances.

System 10 further comprises application software that is operable on computer or processor, the software comprising at least a pair of modules, e.g. exercise/creation therapy module 30 and real-time therapy delivery module 40 that may be run on a single application on the computer.

Exercise/creation therapy module 30 may comprise a plurality of sub-modules, such as exercise creation and editing operations module 32 and therapy program editing and creation operations module 34. Exercise parameterization analysis module 36 and adaption parameters editing module 38 may also be used to modify or build the therapy program in module 34.

Real-time therapy delivery module 40 uses input from one or more sensors 44 (described in more detail below), and may comprise a plurality of sub-modules, such as real-time therapy delivery sub-module 42 for real time user monitoring, visualization, and modification of exercises. Real-time visualization and display sub-module 46 may also be used for delivery of virtual therapy.

An optional visualization cluster 22 may also be used, depending on the virtual reality (VR) configuration, to provide further visualization to the user.

In one embodiment of the present invention, the adaptive therapy system instance 12 may be implemented on an immersive VR configuration. Such a configuration would allow the therapist to immersively model customized exercises by demonstration and to experience high-end visualization of the performance of a patient. The patient's motion can be generated in real-time or it can be loaded from previously logged sessions. The application provides stereo visualization for enhanced comprehension of the observed motions and data. The user's upper body motions may be tracked using a precise motion tracking system (e.g. based on Vicon cameras) for sensor 44. For simpler setup, the system may be configured to only track markers attached to the hands, torso and head. The motion may be calibrated and mapped to the avatar following existing approaches available in the art. When connected to a remote site, two avatars are displayed for representing the connected patient and therapist. Previously recorded sessions can also be played on any of the avatars. The avatars can be visualized side-by-side or superimposed with transparency.

In one embodiment, the experimental immersive setup comprises of a Powerwall system composed of a plurality of rendering computers, a main rendering node and an external computer driving the devices and the motion capture system. This provides a large immersive display that enhances user engagement allowing a better spatial understanding and analysis of motions. The interaction with the application is also fully immersive; thanks to virtual pointers and a 3D GUI interface, which may be controlled by a Wiimote (the GUI provides menus, buttons, generic widgets and panels). Moreover, any other virtual reality hardware setup supporting user perspective 3D stereo vision can be adopted.

In one embodiment of the present invention, the adaptive therapy system instance 12 may be implemented on a portable light-weight configuration. This configuration is configured to assist patients when they perform their exercises. The patient is tracked through a non-cumbersome 3D body motion tracking device (e.g., Microsoft Kinect or similar sensor technologies) and a virtual character and/or virtual therapist helps the patient perform the prescribed daily therapy tasks by providing real-time monitoring, feedback and logging. This configuration may be suitable for use at homes or clinics.

The portable configuration also provides two avatars when a networked connection is established. Even though the accuracy of Kinect is limited (and the accuracy drops when body occlusions occur) it still provides a good tradeoff between cost and portability. Automatic motion detection mechanisms may be provided to improve the usability of the system. For example, automatic display of joint angles may be provided only when significant variation is detected, and an end of exercise may automatically be detected after a period of inactivity, etc.

Details of virtual therapy system 10 are described in further detail below. The description is applicable to both the portable and the immersive versions of the system, with the difference being that the portable version contains traditional desktop in-window menus overlaying the scene, while the immersive interface is presented with panels which are perceived floating in front of the user experiencing the 3D perception of the immersive version.

1. Main Interface

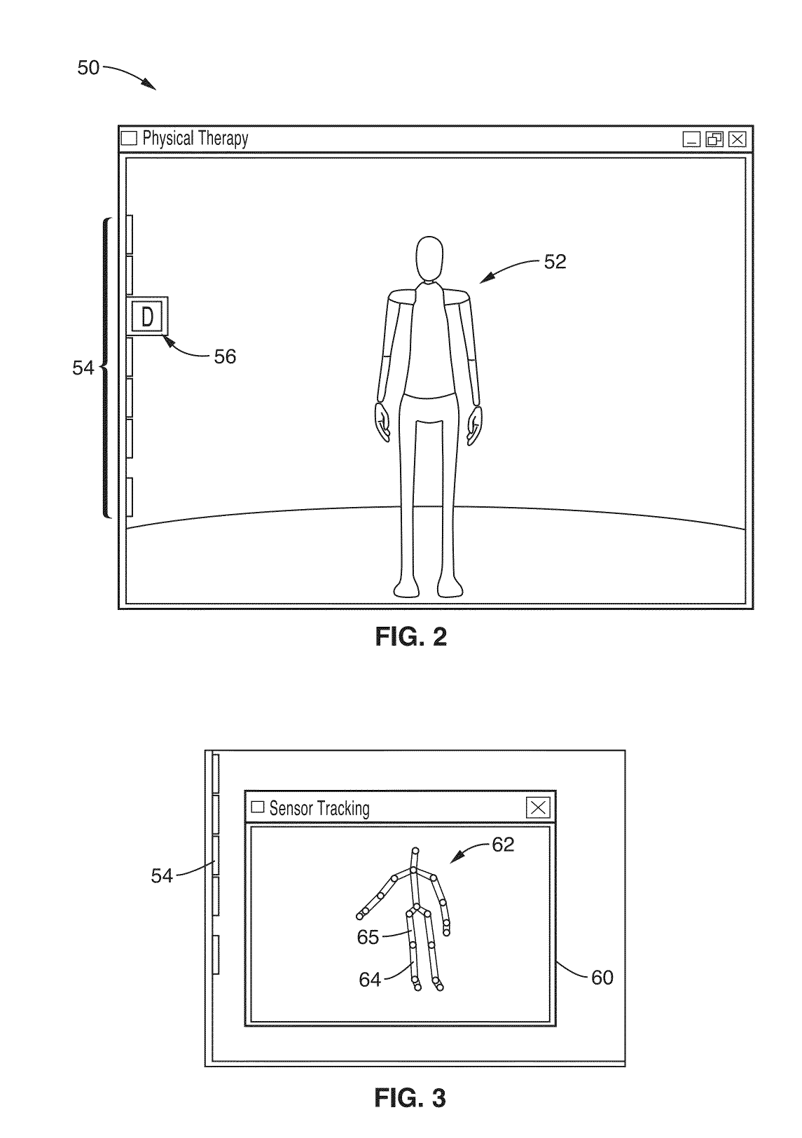

FIG. 2 shows a screen 50 embodying the main interface for the application software. The application generally starts displaying a stylized virtual character (patient's avatar 52 standing in the center of the screen (FIG. 1). The stylized cartoonish appearance of avatar 52 was chosen because perceptual studies indicate that such a style generates a higher comfort level in applications involving virtual human representations. It is appreciated, however, that the avatar 52 may comprise different appearances, which may be selectable by the user or therapist.

The screen 50 includes a main menu 54 that is located in the left and top side of the application window and it is composed by a set of rectangular buttons that preferably disappears if they are not focused by the application pointer 56. The application pointer 56 also fades away if not used.

As shown in FIG. 2, the buttons of menu 54 may be configured to display a “tooltip” floating panel dynamically, if text is present, to help the user understanding the purpose of the button. The main menu 54 is designed to be simple for the non-computer-skilled, simplifying the accessibility and allows for a future use with full-body natural interaction controller. In a preferred embodiment, the main menu is composed of the following buttons: Enable/Disable Online Mode, which allows switching the application state from single user to online multiuser interaction; Enable/Disable the visualization helpers (e.g. Trajectory, Distance, Range of Motion Frequency Map and Floating Angles); Settings Window, which will open/close the application settings window; Scene view control, which shows the controls to rotate the scene; Sensor Window, which will open/close the window displaying the Sensor accuracy reconstruction; Help Window, which will open/close the window with the main application instructions; Exercises Interface, which will open/close the patient's recovery interface; Therapist Interface, which is generally available in applications installed in clinical setup or by pressing a specific button combination, and opens or closes the interface for the generation of new exercises and the creation of therapy program.

FIG. 3 illustrates a sensor tracking window 60 that displays a stylized character 62 made of lines illustrative of the anatomy of the user being tracked by the sensor 44 (e.g. Kinect Sensor). The stylized lines can be color coded, e.g. green, if the sensor is tracking correctly a segment 64, or red, if the sensor has problems inferring the actual pose of a segment 65 of the user. In the case where the sensor 44 is paused, not connected or is not tracking, the window displays a black background. The stylized character can be displayed from three viewing angles: frontal, top and lateral.

A settings window (not shown) may also be provided to include application settings options (for example: application state and sensor reset; sensor inclination controller, virtual camera reset etc.).

2. Patient Interface

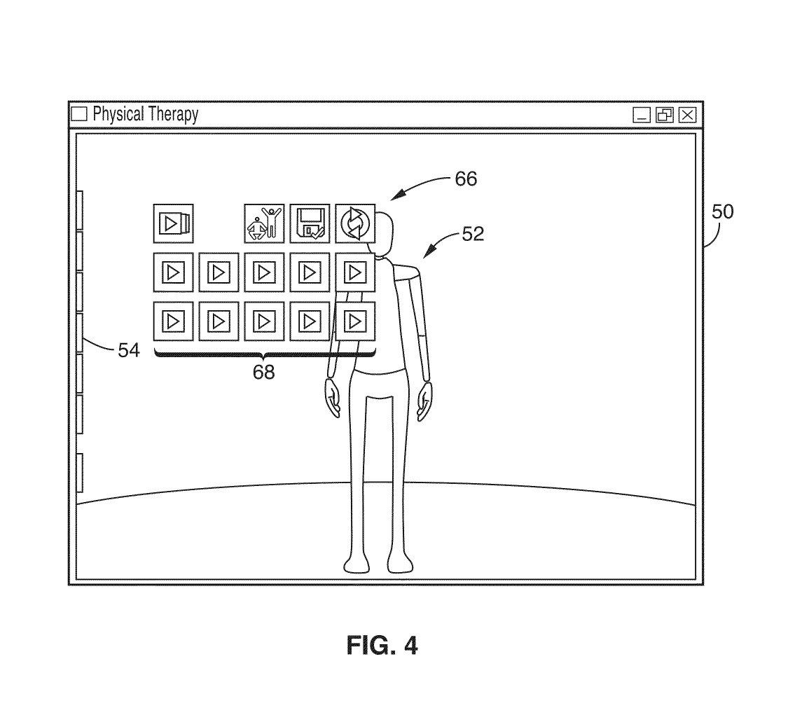

FIG. 4 illustrates a window 50 showing a basic patient interface. When the patient interface is enabled, a set of icons will be displayed on the screen. The first row 66 represents simple functionalities provided to the patient before starting the daily routine.

First icon row 66 may include a button (first on the left) that starts the execution of the therapy program. In a preferred sequence, each exercise will be executed consecutively. Before every exercise starts, a demonstration phase is performed by the avatar (the application also displays optional written instructions and an optional demo video). Subsequently, the exercise execution phase starts.

The demonstration phase can be optionally skipped by the user preventively checking the second icon in row 66. With another button, the user can decide to save their exercise performance on disk or just simply perform the exercises. The last icon in the first row 66 enables and disables the exercise repetitions mechanism (when disabled, the character will ask the user to perform exercises just once).

The subsequent icon rows 68 are generated dynamically according to the therapy program generated by the therapist, using the therapist interface (described in further detail below), and loaded in the application. Each icon may be configured to define a single exercise that can be selected and executed individually by the patient.

The system 10 can be employed as a tool to autonomously deliver exercises to patients at home, and can also be used during clinical appointments to measure and investigate the performance of a patient. In all cases, sessions can be logged and later re-loaded for analysis and progress assessment.

When delivering a patient's daily program, the virtual therapist can start the session by demonstrating the exercises to the patient.

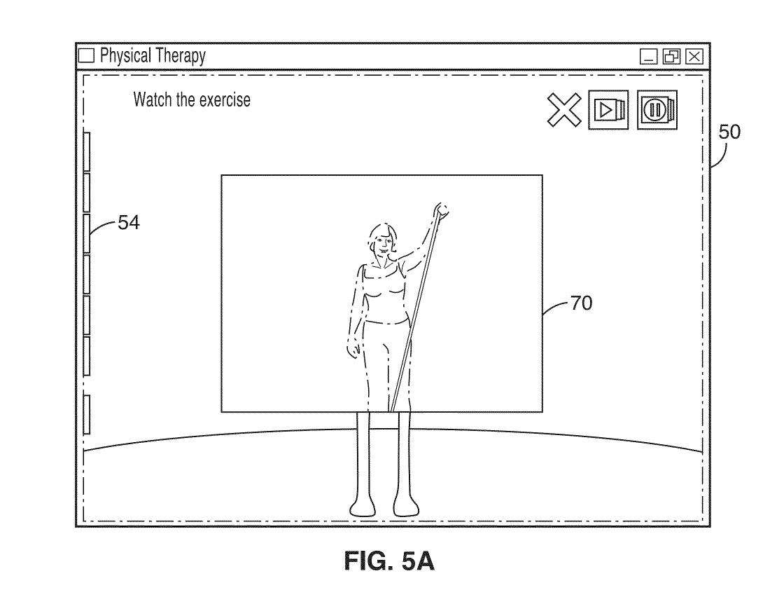

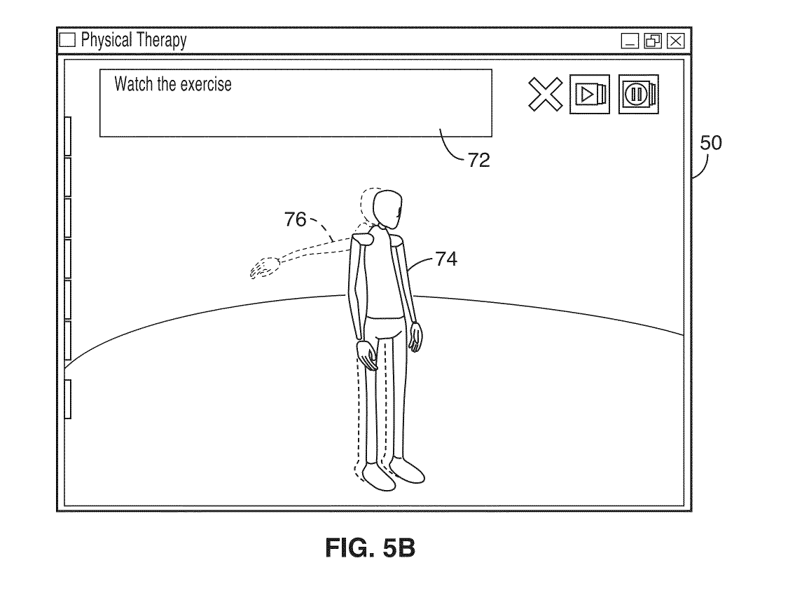

FIGS. 5A and 5B show windows for a demonstration phase interface in accordance with the preset invention. The option of providing personalized (and customized) exercises by demonstration enables the therapist to go beyond recovery plans limited to a set of pre-defined exercises. Any tracking device 44 may be used; however, the accuracy of the device will play a significant role in the quality of the modeled exercises.

The demonstration phase interface is generally loaded when the user selects a single exercise or decides to start the therapy program (before every single exercise). This part can be skipped if the appropriate button is selected in the patient interface. According to the therapy program generated using the therapist interface, window 50 may comprise an optional video 70 with audio for display, as shown in FIG. 5A. If no video is selected, a virtual therapist avatar 76 (which may comprise a color-differentiating, semi-transparent avatar behind the patient's avatar 74; see FIG. 5B) is displayed, and will start performing the motion. The motion can be accompanied with explicative textual content in box 72.

During this phase, three buttons are displayed in the upper right corner of window 50, e.g. skip the current demonstration, stop the demonstration and return to the patient interface, and pause/play the demonstration. Exercise modeling by demonstration is available in both configurations of the system (immersive VR mode: Powerwall and Portable Light-weight mode: Kinect).

In a subsequent step (exercise delivery phase), the user is asked to follow the exercises while the application is recording the sensed motion. If the motion is detected to be significantly different than the demonstrated exercise, the appropriate visual feedback is provided to the user for motivating an improved performance and for better understanding of the exercise. The level of expected compliance and repetitions until compliance can be personalized and defined by the therapist specifically for each patient. This customization of how each exercise is delivered incorporates several other options for automatically adapting the exercises to the patients.

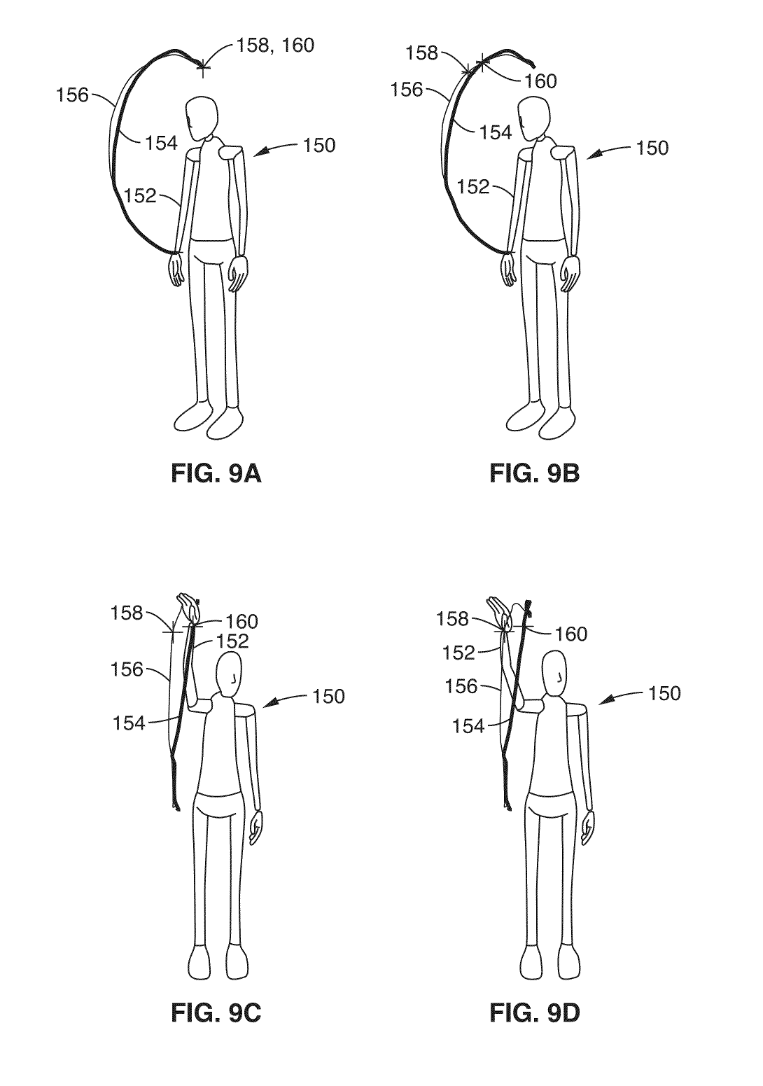

During the exercise delivery, which may be similar to the window 50 shown in FIG. 5B, the virtual therapist avatar 76 and the patient's avatar 74 are displayed overlapped (with the patient's avatar 74 in front). At this stage, the virtual therapist may perform the exercise and the patient can then mimic the virtual therapist motion. Before the beginning of the exercise, a countdown banner may be displayed (giving to the user enough time to prepare before the execution). When the countdown expires, the therapist may then ask the user to follow his motions. Visual feedback (e.g. in the form trajectory trails, joint angles, distance arrows, etc. described in further detail below with reference to FIG. 9A through FIG. 11) may be enabled at this time and the therapist may adapt to the user's motions according to the user's performance as visualized from said feedback.

If more than one exercise's repetitions are required, the system 10 may restore the countdown, giving the patient some time to rest. Depending on the therapy program loaded and if the generated therapy is adapted timing, countdown and avatar's feedback might be different (refer to the therapy program section tab for more details). Anytime during the exercise delivery phase, the system can be paused, restarted or stopped.

The system 10 allows patients and therapists to interact remotely in any configuration, saving travel costs, potentially increasing access to health care, and allowing more frequent monitoring. The motion of each user participating to the virtual collaboration is mapped directly to each respective avatar, and the avatars can be superimposed with transparency or appear side-by-side in the applications.

The communication between two peers in a collaborative session is based on a client-server UDP communication schema with added packet ordering, guaranteed communication reliability and optional data compression. The server application, after accepting and validating an incoming connection, starts sending information of the avatar of the current user (sender) and waits the update of the client's avatar (receiver). For instance, if the therapist application is started as a server, the therapist's avatar becomes the active character in the communication and the second character, the patient's avatar, becomes a receiving entity. If the patient's application is started as the client, the sender entity becomes the character of the patient's application while the tutor/therapist becomes a receiving entity waiting for further updates.

During a networked session each active character maintains a history containing its previous poses and the streamed information between the peers is limited to the information that has changed between the previous frame and the current frame. This feature has been developed to handle communication between peers with limited bandwidth capabilities.

All feedback tools will be available during virtual collaboration. The therapist can demonstrate exercises, analyze the patient motion, load preset exercises from the database, watch the patient's performances and even record a patient motion in real time.

3. Therapist Interface

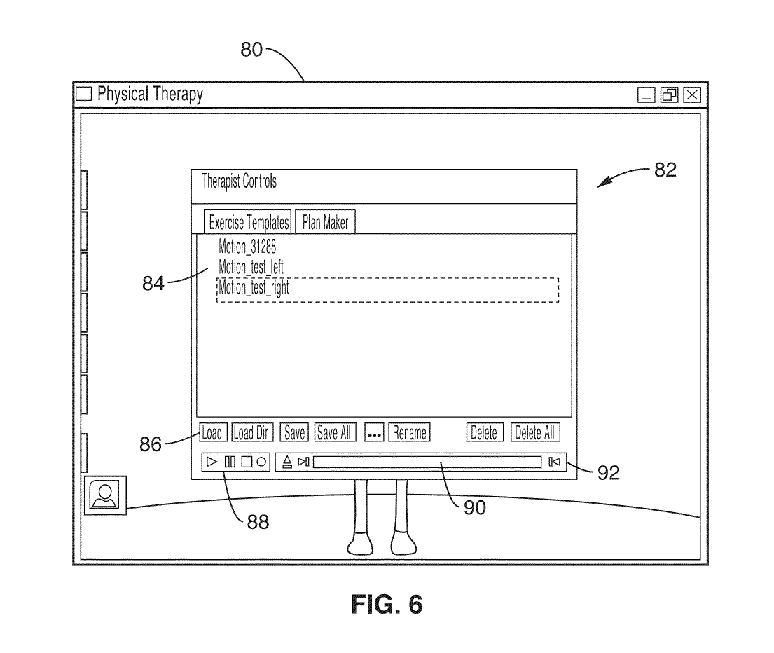

FIG. 6 shows window 80 for the therapist interface, which provides the therapist useful tools to record and modify new exercises as well a platform for the creation of a therapy program tailored to a patients' needs. The therapist interface icon (lower left corner) is usually hidden to a normal application user. The interface can be enabled from the configuration file or by a specific key combination.

Several interactive tools are available for assisting the therapist with creating new exercises by demonstration. The therapist can record his demonstrations and then trim, save, load, play, and customize them in different ways, for example by tuning the playback speed. After a validation process the motions can be saved and categorized in a database of exercises 18 (FIG. 1). The database is then used for fast construction of therapy programs using a desktop-mode interface of the application during consultation with patients, which may then be saved in the database of therapy programs 20.

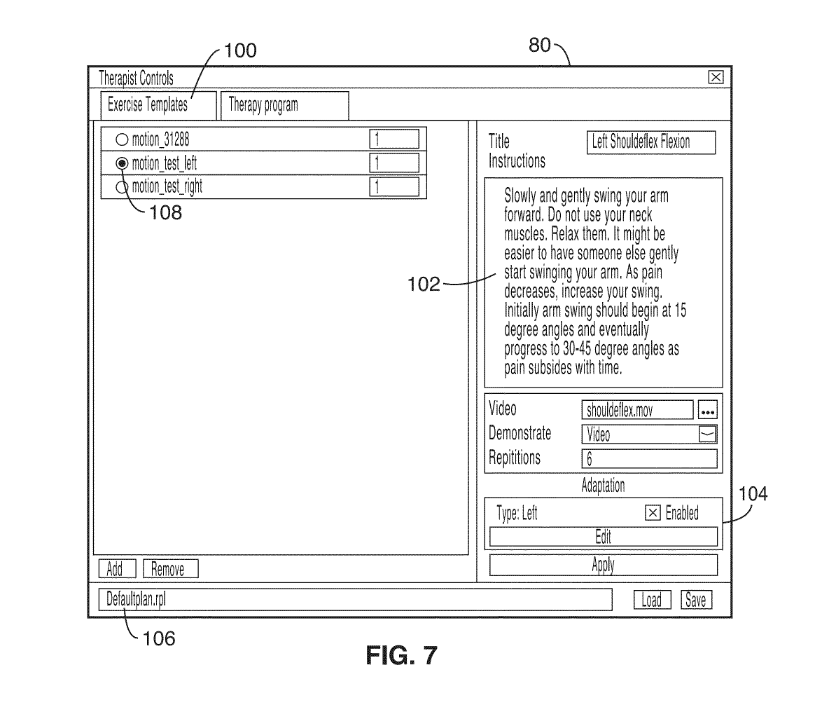

The main window 82 is composed of three tabs 100 (FIG. 7): an exercise template creation and modify tab, an exercise analysis tab, and the therapy program maker tab.

FIG. 6 illustrates a window 80 with the exercise templates tab selected. The exercise templates tab is designed to manage a database of exercises 18. Templates can be loaded, renamed, saved or deleted through simple buttons 86 (some buttons will open external dialog boxes guiding the user through file/directory selection or confirmation/input panes).

When exercises are loaded in the application, they will be displayed in the central panel 82. The same panel is used to select them at selections 84. The selected motions can be played through the player 88, or specific exercise frames can be positioned through the slider bar 90. The modify motion tools button 92 can be used to cut and discard specific parts of the motion (in particular for trimming) or to split.

Finally the record button in the player 88 allows a therapist to create new exercise. After the record button is pressed, a countdown mechanism is started, giving the user some time to assume the initial position. When the countdown expires, the application will start recording the new motion. When the therapist is satisfied with the motion generated, the stop button in player 88 may be pressed in order to conclude the recording. A new exercise is now added in the exercise template list 84 and can now be modified or discarded if the user is not fully satisfied with it.

FIG. 7 shows the therapy program panel 100, which allows the therapist to create customized therapy programs tailored for specific patients or to re-use and assign existing recovery programs. From this user interface, the therapist can select template exercises 108 (previously loaded with the exercise templates tab) that can be customized, in terms of information displayed, delivery method and adaptation behaviors. When the therapist is satisfied with a new generated program, the system 10 generates a package of files that, when loaded by the patient's application, will generate the patient's interface dynamically and customize the delivery of every exercise as specified in the program.

The main therapy program window 80 includes a main panel 100 where template exercises 108 can be added, removed and selected. The templates available are those previously loaded using the template tab. Therapy programs can be loaded from previous packages and saved (name shown at 106).

After selecting a template exercise, the exercise property panel 104 is enabled. This panel provides an interface to customize and select options into text box 102 regarding the delivery of the exercises to the patient. Exemplary options and properties are: a user-friendly exercise name; textual information and explanation of the current exercise; an optional video file with visual and audio instructions; a menu to select if the exercise is to be demonstrated to the user by the virtual therapist, the virtual therapist with text information, or by video instructions; the number of exercise repetitions that the patient needs to perform; the wait-time between the exercise repetitions, etc.

When a template exercise 108 is loaded in the application, the motion is analyzed by the parameterization analysis algorithms (described in further detail below). If the system 10 decides that the exercise meets the parameterization requirements, a new portion of the pane 104 I is enabled. The adaptation and parameterization panel is displayed if the exercise can be parameterized and the type of parameterization is displayed. For shoulder articulation, the possible types include: Left Arm; Right Arm; or Both Arms adaptation. This sub-panel also allows the user to: enable and disable the automatic adaptation for the current exercise; and open the exercise parameterization and adaptation window.

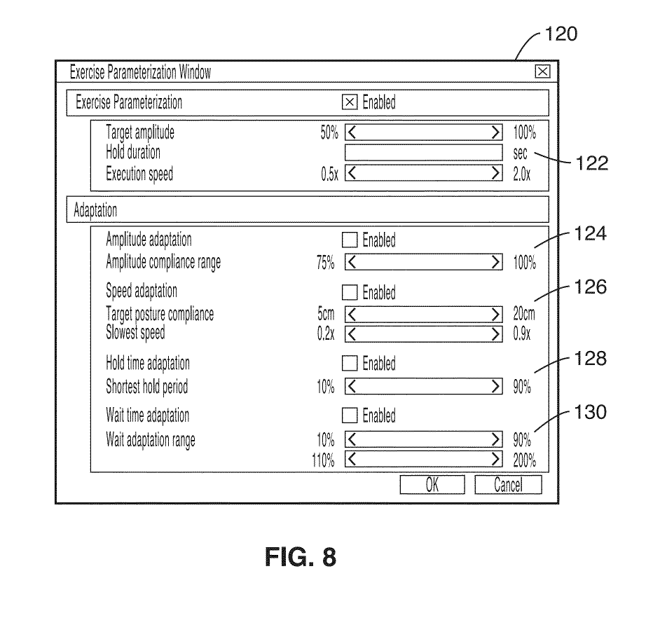

FIG. 8 shows parameterization and adaption window 120, which allows the virtual therapist to adapt exercises to the user's performances.

System 10 advantageously uses at least four types of feedback in order to provide visual and quantitative information about the user motions in real-time. Visual helpers can be activated anytime during collaborative sessions or for analysis of recorded sessions.

As shown in FIG. 9A through 9D, trajectory trails 154 and 156 of selected joints can be updated in real-time, displaying positions of a fixed past period of time, or of complete motions. The visualization can be based on polygonal segments for precise analysis of tremors, or smoothly generated by B-Spline interpolation.

While the system and method of the present invention can be applied to many different body segments and joints, the embodiments shown herein are focused on shoulder evaluation, due the importance of upper extremity function and critical need for an appropriate rehabilitation program.

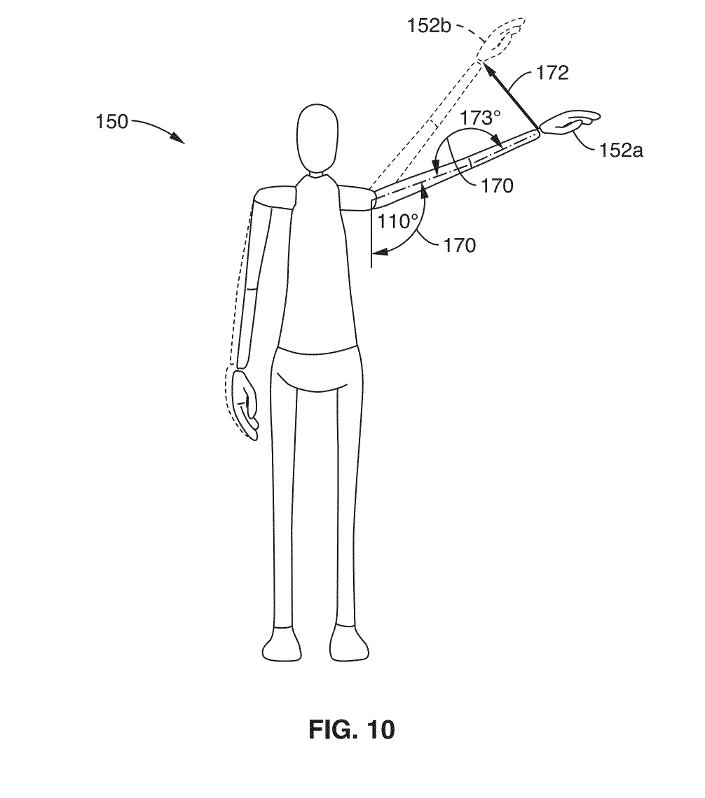

As shown in FIG. 10, joint angles 170 of avatar 150 can be visualized with a floating label showing the angle value and the local lines representing the angle measurement. In practical goniometry for upper-limbs, physiotherapy angle measurement is important to measure progress and intervention effectiveness, via therapy or also surgery. The provided angle measurements match the angles measured in practical physiotherapy protocols.

The proposed method allows the system to measure any kind of angle by just defining pairs of joints and optional reference frame rotations. The tracked angles are specified in the application's configuration file. It gives to the therapist a flexible and easy mechanism to identify and customize the visualization. To isolate angles for upper-arm flexion (extension or abduction) we track, for instance, the angle generated by the scapula/clavicle and humerus, given the scapula bone aligned to the torso as a consequence of the skeleton hierarchical structure. The measured angle is the angle between the arm and the “body line” of the user. In default behavior, angles are only displayed when significant motion is detected.

As further illustrated in FIG. 10, colored-coded 3D arrows 172 of avatar 150 may also be provided for showing the distance between corresponding pairs of joints (e.g. 152A and 152B), each belonging to a different character. Such distance arrows are useful for the patient to track compliance with the demonstrated exercises. The feedback may be useful in individual sessions or in remote physical therapy sessions. The arrows 172 being visualized can be programmed to automatically disappear if the corresponding distance is under a given threshold.

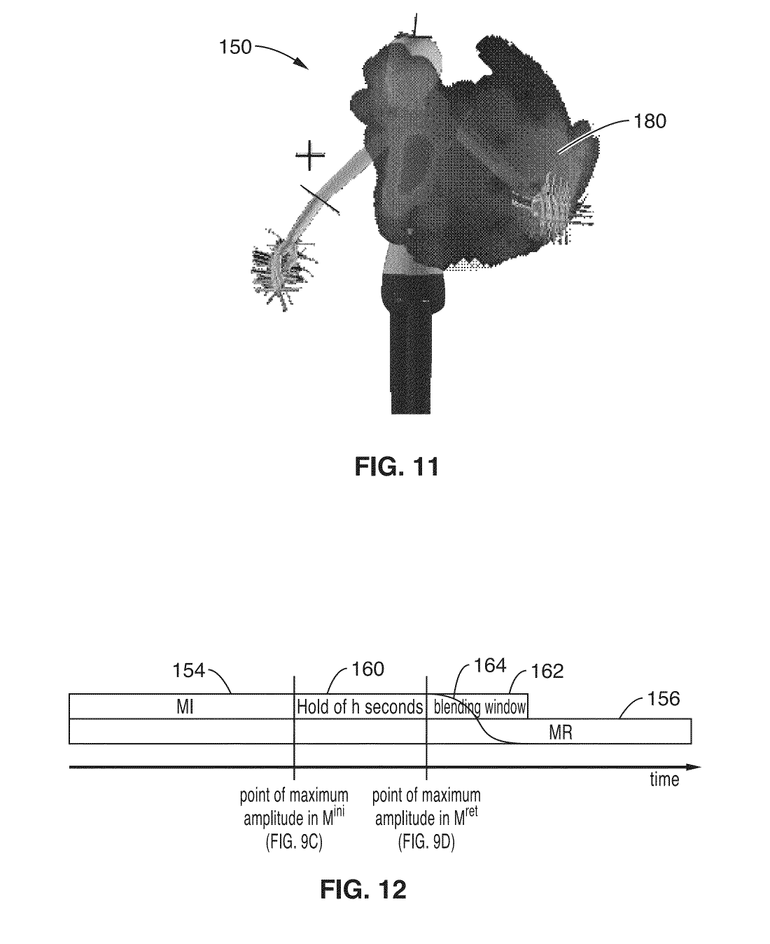

Finally, a fourth feedback method may comprise a range of motion frequency map 180 for avatar 150 as shown in FIG. 11. The 3 degrees of freedom (DOFs) of the shoulder joint are decomposed into the twist and swing rotations of the upper-arm. The swing motion is then tracked at every frame i, and for each swing orientation sᵢ measured, the intersection point pᵢ of the upper-arm skeleton segment at orientation sᵢ and a sphere centered at the shoulder joint is computed. The history of all traversed pᵢ points in a given exercise set is visualized with colors in the sphere. The sphere is texture-mapped with an image texture initially fully transparent. For every measured point pᵢ, its position in the texture is determined and the corresponding texture pixel cᵢ has its color changed to reflect the number of times the patient has reached that swing rotation. In one exemplary configuration, colors are incremented from pure blue to red, providing a colored frequency map 180 of all traversed swing orientations. The color red represents the orientations that were used with most occurrences, while the color blue will represent orientations that were used with low number of occurrences.

To achieve a clear and smooth diagram for visualization, a relatively high texture resolution was employed and the color increments were weighted around cᵢ with a local Gaussian distribution centered at cᵢ. This has the effect of smoothing the new color with the colors of the neighbors of cᵢ. The obtained boundary of the colored map represents the range of motion executed by the patient in a given exercise, and the colors of the frequency map obtained will show how much the user deviated from the prescribed exercise. In a perfect scenario, if the user closely follows a prescribed exercise, the frequency map shows a clear red trajectory along the rotations employed by the upper arm. In practice, many imperfections happen and the frequency map reflects how much the areas nearby the correct area were used.

This frequency map visualization tool provides a unique and novel representation for helping therapist to detect if there are areas of shoulder movement that the user tries to avoid while executing an exercise. This represents a non-obvious method to track and visualize motion that can be used not only in shoulder dysfunctions but other body segments and joints. After a series of repetitions of one given exercise, the obtained shoulder frequency map can be saved for later analysis. Frequency maps can be saved per exercise, per day, and per patient. Frequency maps are images that can be placed together to form a video displaying the progress achieved by the patient for each exercise type along the whole period of the therapy program. The frequency map therefore presents itself as an excellent way to log generic improvement of shoulder range of motion during rehabilitation, which is often the main objective of a therapy program. The frequency map 180 also provides a novel way to compare the effectiveness of different exercise programs by comparing the improvements obtained by patients executing different programs.

The template exercise selected for a program is first analyzed by the system 10, and local features are extracted in order to parameterize the motion, as illustrated in FIG. 9A through 9D, showing trajectory trails of avatar 150 though a shoulder flexion exercise of a patient's right arm 152 at various angles. The system 10 identifies if the exercise contains similarities (or cycles), and describes them with three major components: the initial phase shown through trajectory trail 154, the hold phase (at apices 158, 160), and the return phase shown through trajectory trail 156. The points defining the connections between the two phases are called apices 158, 160.

For example, in a shoulder flexion exercise, the patient is usually asked to raise an arm until it reaches the vertical position or more (initial phase); subsequently to hold that position for few seconds (hold phase) and, finally, to relax the arm back to a rest position (return phase). The three phases are displayed by the system through lines 154, 156 (trajectories) that cover the traversed position in space of the character's hands. Different colors may be used to identify the different phases.

The position of the apices (or maximal points) 158, 160 along the trajectories 154, 156 are parameterized and described by the application through a simple percentage parameter called target amplitude. The hold phase is parameterized through a time window parameter called hold duration.

The exercise parameterization and adaptation window 120 shown in FIG. 8 may be enabled if the exercise is determined to allow for parameterization. From this window, the user is able to vary parameterization, through sliders 122, the target amplitude (from 50% of the original motion amplitude until 100%); the hold duration time (in seconds) and the execution speed of the overall exercise (from the half of the speed time until double the speed).

Varying the target amplitude results in generating a new exercise with different amplitude, yet that still maintains the overall appearance and properties of the original one. The apices are scaled along the generated trajectories, and when the new motion is played, the avatar 150 starts executing the exercise until it reaches the position of the first scaled apex 160. After this stage, the system switches to the second phase keeping the hold phase active until the hold duration time is expired; during this time the systems blends the poses between the two scaled apices 158, 160 (by “ease in-ease out blending,” see the Section B below). Finally the return phase 156 of the motion is executed from the second scaled apex 158. The overall original scaled motion's velocity profile is also applied to the new synthesized motion. The initial value assigned to the hold duration phase is assigned to be equal to the time window defined by the discovered hold phase duration detected in the original input motion. Depending on the type of motion loaded the hold duration value can be zero.

Besides the generation of parameterized exercises, the system also provides autonomous adaptation mechanisms. The adaptation process is designed to respond to the user's needs in real time. The exercises are designed to push (within the limits of the designed therapy) the patient to gradually improve his range of motion, endurance and resistance. The adaptation also considers the possibility of scaling down the exercises (in terms of speed, wait and hold times, and amplitudes) in order to adapt to patients with slower progress rates. The system therefore dynamically adjusts the therapy parameters (always bounded by the therapist choices) by continuously updating by small variations at each exercise repetition the exercise properties according to setting specified by the therapist.

Sliders 124, 126, 128, and 130 of FIG. 8 apply to the adaptation mechanism of the present invention. When the adaptation mechanism is enabled, the system 10 collects information about the patient's performance during the exercise execution in real-time in order to adapt the current exercise in its next repetition. When the next exercise repetition takes place, the exercise parameters are adapted considering the patient's previous performance and the parameters variation ranges specified by the therapist for the current program.

The system provides four types of interactive adaptation mechanisms: amplitude adaptation 124, speed adaptation 126, hold-time adaptation 128, and wait-time adaptation 130.

The amplitude adaptation through slider 124 is specified through the amplitude compliance parameter. The compliance range can vary from 75% until 100% of the target amplitude parameter. When the amplitude adaptation is in place the system tracks the distance between the patient's active end-effector and the target apex at the target amplitude position. The end-effector can be the left hand or the right hand, and in case both hands are being parameterized then the left and right hands are tracked in parallel. If the minimum distance between the user performance and the target position at maximum amplitude is larger than the amplitude compliance parameter specified by the therapist, the next exercise execution will have the target amplitude lowered to the position that makes the position reached by the user to become within the compliance range. If in a subsequent repetition the user reaches the current (reduced) target amplitude, then the next target amplitude will be increased towards the original target amplitude, always guaranteeing that the amplitude of the user performance is within compliance range with respect to the demonstrated exercise. Finally, the amplitude adaptation mechanism is always bounded by 50% of the overall exercise amplitude.

The hold phase adaptation slider 126 is designed to offer a process that provides execution flexibility when the patient is asked to maintain a hold stance to improve resistance, usually in a posture that becomes difficult to maintain over time. The parameter involved in this adaptation process is the shortest hold duration accepted. This parameter, expressed in seconds, defines the minimum time that the user is required to keep the active end-effector position close to the current exercise end-effector position at the hold phase. During the hold phase, the maximum distance between the target and the performed end-effector position is computed. If that maximum distance is above a threshold, this means that the patient is having difficulty in maintaining the demonstrated posture during the hold phase and the next exercise repetition will have a shorter hold phase duration time. Let x be the time associated with the pose detected to have the maximum distance. The next exercise execution hold time will be decreased to x+(current target duration−x)/2. If in a subsequent repetition the patient is able to maintain the hold posture well during the entire current hold phase period, then the hold duration is increased back to its previous value, eventually reaching back to the target values originally set by the therapist. The minimum duration that the system is allowed to use during the adaptation process is bounded by the shortest hold duration parameter that is specified by the therapist.

The speed execution adaptation slider 128 is defined by selecting a target posture compliance parameter and a minimum (slowest) play speed factor. During patient monitoring, the active position of the patient's end-effector is tracked and its distance to the demonstrated exercise end-effector is computed for every frame. The distances are the lengths of the arrows 170, e.g. shown in FIG. 10. If the average distance computed across the entire exercise is above the given posture compliance threshold parameter, the next exercise execution speed is decreased. If in a subsequent repetition the difference is under the threshold, the play speed will be adjusted back towards the original target execution speed. The same mechanism as described by the hold phase adaptation is used. The posture compliance threshold is bounded between a 5 cm and 20 cm distance and the slowest play factor cannot be less than 0.2× of the initial input execution time.

The wait-time adaptation mechanism slider 130 allows the system to update the waiting time between exercise repetitions. If the user is performing the exercises well, a shorter wait time is allowed, otherwise a longer wait time is preferred. The target wait time is specified in the therapy program interface. Here we allow the therapist to decrease or increase the wait time, allowing the patient to have more or less time to rest between exercises. A performance metric is used to determine how well the patient is following the exercises. The metric is based on checking how well the target parameters are being met. Let Acε[0,10] be the amplitude compliance coefficient, Scε[0,10] be the speed compliance parameter, and Hcε[0,10] be the hold time compliance parameter. Each compliance parameter tells how many of the last 10 exercise repetitions where performed successfully, meeting their targets. The final performance metric is computed with m=(Ac+Sc+Hc)/30. Parameter m is therefore a value in [0,1]. The therapist specifies the minimum (Min) and maximum (Max) wait times allowed via slider 130. We then determine the wait time to be Min+(Max−Min)*m. The wait times are not updated at every exercise repetition. After a given exercise has finished its repetitions, the corresponding wait time for that exercise is computed and then used for the next time the same exercise is performed. This allows achieving wait times that are related to the measured difficulty of each exercise.

It is appreciated that described adaptation strategies above are merely a few of those of interest to therapists. Many variations and adjustments are possible, and the system 10 may be configured with any number of adaptation and parameterization schemes.

The system also includes an exercise analysis tab (not shown) that is designed to give visual and numerical tools to the therapist in order to allow them to analyze the patient performances recorded through the patient interface.

B. Motion Parameterization Methodology and Adaptive Delivery Algorithms

A preferred embodiment for adaptive delivery of exercises utilizes automatic parameterization of exercises recorded from demonstrations provided by therapists.

During exercise creation, the therapist may hit a keyboard key or press a user interface button to start recording a new exercise, and then positions himself/herself in front of Kinect (or another sensor) 44. The entire motion performed in front of the sensor 44 and is recorded. To stop recording the exercise, the therapist presses another key (or user interface button). After this recording phase, the system 10 will display the recorded motion by playing it in a virtual character 150 so that the therapist can accept it or reject it. If the motion is accepted, the therapist will then be asked to trim the start and end points of the motion. This is needed because there is always an unwanted portion of the motion that is recorded before the start and after the end of the exercise; these are the periods where the therapist was interacting with the computer, getting ready, etc.

After the motion is accepted and the end points trimmed, the system automatically analyzes the motion in order to determine if the motion can be parameterized or not. Only motions that can be parameterized can generally be delivered in an adaptive way. The parameterization analysis segments the exercise motion in phases, and then prepares the motion for allowing it to be modified on-line with different speeds, amplitudes, and hold and wait times. These parameters are then made available to the adaptive delivery module in order to achieve exercises that adapt to users on-line.

1. Parameterization Analysis

An exercise motion demonstrated by the therapist is mapped to a character hierarchical skeleton representation and stored in the computer memory as a time-series Mᵢ, iε{1, . . . , n}, where each frame Mᵢ is a vector with all joint angles defining one posture of the character representation. Our time-series representation also stores at every frame the time (in seconds) that the particular frame was captured during the demonstration of the motion. The times are normalized such that the first frame will have time 0 and the last frame will have the total duration of the motion. We use here the notation time (Mᵢ) to denote the time associated with frame Mᵢ. Therefore time (M₁)=0, and time (Mₙ) is the total duration of the motion. The proposed automatic parameterization first analyzes the input motion Mᵢ in order to extract key features for parameterization.

The analysis procedure makes the following assumptions:

a) each motion Mᵢ represents one cycle of a cyclic arm exercise that can be repeated an arbitrary number of times (where the focus is on arm exercises for shoulder rehabilitation);

b) the first frame of a motion (frame M₁) contains a posture that is in a comfortable position representing the starting point of the exercise; this start posture should always be used as the starting point of the exercise and should not be altered when the amplitude of the exercise is later on changed;

c) the exercise will have two clear distinct phases: the initial phase 154 (FIG. 9A through FIG. 9D) is when the arm moves from the initial posture (M₁) towards a posture of maximum exercise amplitude, then the exercise may or not have a hold phase but at some point the exercise must enter the return phase, where the exercise returns to the starting posture at the end of the exercise. This implies that M₁ contains approximately the same posture as Mₙ;

d) finally, if the motion contains a hold phase at the point of maximum amplitude, it will mean that an approximately static pose of some duration (the hold phase duration) exists at the maximum amplitude point.

In addition to the 3 phases mentioned above we also consider an optional 4^{th} phase that can be added to any exercise. This is the wait phase, which is an optional period of time where the character just waits in its rest pose before performing a new repetition of the exercise.

FIG. 9A through FIG. 9D illustrates a typical exercise that fits the above assumptions. Note that the exercise is demonstrated in a generic way by the therapist, and as long as the assumptions above are met, our automatic analysis will provide the ability to modify the demonstrated exercise on-line during therapy delivery.

In one exemplary exercise, the initial phase 154 happens between t=0 s and t=3 s. Then, between t=3 s and t=4.85 s, there is a hold phase at maximum amplitude (e.g. apices 158,160) where the therapist is static (but small posture variations are always noticeable). Then, between t=4.85 s and t=7.55 s, we can observe the return phase 156, which ends at posture very similar to the initial one. The trajectory 154, 156 is the trajectory of the right wrist joint along the entire motion. It can be noticed that the initial trajectory and the return trajectory are very similar but are not exactly coincident, since it is difficult for the therapist to perform a perfect motion. By allowing the therapist to demonstrate motions directly, any customizations (for example small variations of spine postures etc.) are captured allowing the therapist to customize exercises to specific patients. Our system will also reproduce during the parameterization process any small imperfections that are captured, which makes the behavior of the virtual therapist to appear humanlike and more engaging during therapy delivery.

Given an input motion, the analysis, if the motion can be parameterized, has the following steps:

a) automatic detection of which arm(s) are being parameterized (this would be the right arm 152 in the FIG. 1 example);

b) automatic detection of the two motion apices, or the points of maximum amplitude that are the intersection points between the initial and return phases and the hold phase (these would be the frames at t=3 s and at t=4.85 in the example of FIG. 9A through FIG. 9D; these points will result in a single apex point if the motion has no hold phase in it);

c) if two distinct apices points are found (one at the end of the initial phase 160 and another at the start of the return phase 158), then two apices points are detected and the motion piece in between is extracted as the hold phase.

If all the phases above are executed successfully and the input motion can be segmented in initial, return and an optional hold phase, the motion can then be parameterized and the motion is prepared for on-line parameterization with the additional procedures:

a) velocity profile extraction of the parameterized arm, so that the same profile can be used when the motion is changed to a reduced amplitude, and

b) preparation and segmentation of all phases so that the sub parts of the input motion are ready for on-line blending in order to achieve a smooth result when adapting the motion to different hold times and amplitudes.

All these steps are described in detail in the next sections.

2. Detection of the Arm to be Parameterized

Given the input motion Mᵢ to be parameterized, for each frame of the motion, we extract the global position of the left and right wrist position in the corresponding pose, and store the positions in two new time-series Lᵢ and Rᵢ. All “time-series” are stored in contiguous memory arrays of fast indexed access to each element. Since we are focusing on arm exercises, the wrist represents an obvious distal joint of the arm kinematic chain to use in our parameterization analysis algorithms.

For each wrist trajectory array, Lᵢ and Rᵢ, we compute the 3D bounding box containing its full 3D trajectory, and then the maximum dimension of each of the two bounding boxes. If the maximum dimension of the bounding box of Rᵢ is greater than the maximum dimension of the bounding box of Lᵢ, it means that the motion of the right arm covers more space than the motion of the left arm and thus the right arm is detected as the primary arm to be parameterized. Similarly, if the left arm is detected to cover more space, the left arm is then selected as the primary arm to be parameterized. If the maximum dimension of the bounding box containing the trajectory of the primary arm is not large enough (at least 20 cm), then the motion is not considered to be a meaningful exercise and the algorithm returns that the motion cannot be parameterized.

If both arms produce significant space coverage, we then perform the following test: if the maximum dimension of the bounding box containing the trajectory of the primary arm wrist is close (by 75%) to the maximum dimension of the bounding box containing the trajectory of the other arm wrist, then the exercise is assumed to contain a both-arm motion and the parameterization will select both arms to be parameterized. This procedure targets exercises of both arms performing symmetrical motions, therefore the trajectory of both the wrists is considered similar. The parameterization operations can therefore be computed with respect only to the primary arm, and only specific per-arm corrections will have to be applied to both arms

As a result of this process, the analysis will return one of the following four options:

a) the motion cannot be parameterized;

b) the motion will be parameterized by the left arm;

c) the motion will be parameterized by the right arm; or

d) the motion will be parameterized by both arms.

3. Apex Frame Determination

Once the parameterization type is determined, we then search the motion for the apices points 158, 160 of maximum amplitude. Since the motion may or may not contain a hold phase, we perform the search in two steps: one forward search starting from the first frame, and one backward search starting from the last frame.

To detect one apex point we search for a frame that indicates a sharp turn in trajectory. This makes sense since all exercises of interest consist of smooth trajectories toward an apex point, and then continuation towards the opposite direction in order to directly return to the initial pose. Even if there is a hold phase, the initial direction will suddenly change at some point and enter into hold. We therefore search for two apex points by detecting the first significant change in trajectory direction when searching forward and backwards along the input motion.

Let i be the index of the current frame being evaluated if it represents an apex point. Let T represent the time-series containing the trajectory of the left of right wrist joint, that is, T, will be R, or L. In order to determine if Mᵢ represents an apex point with respect to the trajectory in T we perform the computation steps described below.

1) We first compute the incoming and outgoing direction vectors with respect to Tᵢ, respectively:

a=Tᵢ−Tᵢ₋₁, b=Tᵢ₊₁−Tᵢ.

2) If a or b is a null vector, that means we are in a stationary pose and we therefore skip frame Mᵢ and no apex is detected at position i.

3) Otherwise, the angle α between vectors a and b is computed and used to determine if there is a sharp change in direction at position i. If a is greater than a threshold angle, frame i is considered an apex point, otherwise we skip frame i and proceed with the search. We are using a threshold of 75 degrees and this value has worked well in all our examples with clear detections achieved. Good results can also be obtained by analyzing the 2^{nd} derivative of the trajectory; however, working with an angle threshold in degrees has proved to be more intuitive.

The test described above is first employed for finding the first apex point when searching forward all frames of Mᵢ (starting from the first frame). The first apex found is called Apex 1 and the index of the Apex 1 frame is denoted as a₁. If no apex is found, the overall algorithm returns that the motion cannot be parameterized.

If Apex 1 is successfully found, then the search is employed
backwards starting from the last frame, however not allowing passing beyond Apex 1. The apex found during the backwards search is called Apex 2 and the index of the Apex 2 frame is denoted as a₂. Note that Apex 2 may be the same as Apex 1, in which case no holding phase is present in the input motion.

After the described analysis, the main three portions of the motion have been detected:

a) the initial phase is defined by frames {1, 2, . . . , a₁};

b) the hold phase is defined by frames {a₁, a₁+1, a₂}, if a₂>a₁, and inexistent otherwise; and

c) the return phase is defined by frames {a₂, a₂+1, n}.

At this point two new motions are created: M^{init} contains the initial phase of M, and M^{ret} contains the return phase of M. The original portion of M containing the hold phase is discarded.

4. On-Line Parameterization Algorithm

Once an input motion M is successfully segmented into the initial and return phases, it can then be parameterized with respect to different amplitudes and hold durations.

Parameterization of Amplitude

We parameterize amplitude in terms of a percentage of the wrist trajectory: 100% means that the full amplitude observed in the input motion M is to be preserved, if 80% is given, then the produced parameterized motion should go into hold or return phase when 80% of the original amplitude is reached, and so on. Let h be the time duration in seconds of the desired hold duration. When the target amplitude is reached, the posture at the target amplitude is maintained for the given duration h of the desired hold phase. When the hold phase ends, the posture is “blended into” the return motion M^{ret} at the current amplitude point towards the final frame of M^{ret}. The blending operation ensures that a smooth motion is always produced. Velocity profile adjustment and an idle behavior are also added in order to ensure a realistic final result. FIG. 2 presents an example before we explain in greater detail the involved procedures.

Referring to FIG. 9A through FIG. 9D, the trajectory 154 shows the initial phase segmented out of the input motion. The trajectory 156 shows the return phase segmented out of the input motion. (a) The full (100%) amplitude of the input motion is shown by the trajectories. Two crosses at the end of the trajectories (in almost identical positions) mark the positions of Apex 1 (160) and Apex 2 (158). (b) The two crosses now mark the maximum amplitude points in the initial and return trajectories at 75% amplitude. FIG. 9A and FIG. 9C show a frontal view, as it is possible to notice that the postures at 75% amplitude in the initial and return phases are different, and that is why a blending operation is needed. The hold phase will hold the end posture in the initial trajectory at the target amplitude (posture shown in c), and when the hold phase is over, the posture is blended into the return motion in order to produce a smooth transition into the return phase.

The performed blending operations, and in particular ease-in ease-out blending, is illustrated in FIG. 12. Ease-in ease-out blending is performed in order to smooth the transition from the maximum amplitude posture of the initial phase 154 into the corresponding posture in the return phase 156. The blending 164 occurs during a blending window 162 after the hold phase 160 set to 0.2 seconds. We use the cubic blending curve f(t)=−2 t³+3 t² in order to compute blending weights f(t) inside the blending window, where t=0 represents the beginning of the blending window, and t=1 the end of the blending window.

The described blending operation is enough to achieve a continuous parameterized motion; however, one undesired effect may happen. This is a noticeable abrupt stop of the motion at the start of the hold point. This may happen because we are suddenly interrupting the motion at a point where the motion may have some significant velocity, and a typical continuous motion should exhibit a bell-shaped velocity profile. In order to remain as close as possible to the behavior in the original recorded input motion we extract the original velocity profile of the full extent of motion Mⁱⁿⁱ, then we scale it to the desired new amplitude, and then adjust the keytimes (time information associated with each frame of Mⁱⁿⁱ) in order to achieve the same velocity profile of the end-effector in the reduced portion of Mⁱⁿⁱ that covers the new lower amplitude currently selected.

The velocity profile adaptation is based on the analysis of the velocity profile of the trajectory of the end-effector (in our case the wrist). Since we have stored in arrays L and R the original trajectories, we can at any time re-scan the velocity profile of these trajectories and scale it to a scaled-down profile for any reduced amplitude.

The parameterization of the hold time just affects the selected duration to remain at the hold posture. In order to improve the realism, we can add a small oscillatory spine movement mimicking a breathing motion commonly observed in a posture hold. This small oscillatory motion is added to the spine joints during the hold phase and it results in small movements that make the character look more humanlike during the hold phase. The same technique is used during wait times between two different exercises (a parameter independent of exercise parameterization). A character is achieved that is never completely static and that exhibits at least a small breathing oscillatory spine motion in static postures.

One particular problem that needed to be addressed was to produce an oscillatory motion that ensures the oscillation ends with no contribution to the original pose at the end of the oscillation period. This is needed so that, after the oscillation period, the motion can smoothly continue towards its next phase without the need for additional blending operations. This means that we have to be able to produce oscillations of controlled amplitude and period. This is accomplished with the following function:

f(t)=sin(t*π/d)d, if d<1, and

sin(t*π/(d/floor(d))) otherwise,

where d>0 is the duration of the oscillation period, which in our case will be the duration of the hold or wait periods.

We use this oscillation function to generate a breathing behavior for static periods. At the beginning of a hold phase (or wait phase) we save the joint angles of the spine in a vector s, and then, for each value inside the breathing behavior period, we put back to the spine joints the values of s+c f(t), where tε[0, d], and c is an amplitude constant. We obtained good behavior with c=0.007, and only operating on one degree of freedom of two spine joints: one near the root of the character hierarchy, and one about at the center of the torso. The used degree of freedom is the one that produces rotations on the sagittal place of the character.

The exact same procedures of applying a breathing behavior and blending into the next phase are applied to both the hold phase and the wait phase. In the case of the wait phase, when the user selects to have the character to stand in wait phase for a given period of time, the blending occurs after the wait phase, towards the first frame of the initial pose of the input motion, in order to smoothly continue over the next repetition.

Finally, the parameterization is then easily extended in terms of speed, following a multiplier parameter that specifies how much faster a given exercise should be “played”. If the speed parameterization parameter, s, is set to 2, the exercise will be played two times faster, if it is set to 0.5, it will be played with half of the original speed, etc. To achieve this, s is treated as a scale factor multiplied to the time parameterization of the motions.

The described procedures, therefore, allow us to parameterize an input motion M with respect to three parameters: amplitude a (in percentage), hold time h (in seconds), and speed s (as a multiplier to the original time parameterization).

Given a set of parameters (a, h, s, w), the input motion can be prepared for parameterization very fast, with total computation time below 0.1 seconds in an average computer. This includes the velocity profile transfer and the determination of the new apices points in the reduced amplitude of a. Then, during execution of the parameterized motion, only trivial blending operations are performed and they are executed in real-time with just a few milliseconds of computation per frame.

5. Automatic Alignments

The presented parameterization algorithms operate with the goal of re-using the original input motion as much as possible in order to produce parameterized exercises that are very similar to input motion. Additional tools are provided for the user (therapist) to modify a given exercise in terms of alignments and symmetries.

Trajectory Symmetry: if the user desires to have identically symmetrical initial and return phases, a simple operation is provided to copy the movement of one arm to the other, after a mirror of the arm joint angle values. This tool is only available if the motion can be parameterized. The additional operations described below are generic to any type of motions.

Generic Alignment: with this option the system will fit a plane to the trajectory points of each of the wrist joints, and will project the trajectory to the plane, so that the motion becomes perfectly placed in a single plane.

Canonical alignment: with this option, planes along each of the main axis of the character (sagittal, coronal, and transverse) are placed on the shoulder and elbow joints and for each plane that the trajectory is close enough to, the user is given the option to project the entire trajectory to the plane. In the examples of FIG. 9A through FIG. 9D, the sagittal plane would be detected and if selected the exercise would be perfectly aligned to the sagittal plane.

Velocity alignment: with this option the velocity profile of the entire motion is replaced with an ease-in ease-out bell shaped profile with given parameters. This allows the user to create exercises with precise velocity control.

These tools are provided as operations that can be individually selected as needed, and gives the flexibility to start from a demonstrated “sketch exercises” and gradually fine-tune them into a perfectly aligned and symmetric exercises, if so desired, at the cost of losing some of the humanlike realism of the original input motion.

6. Adaptation Strategies

Once an input motion can be parameterized according to the parameters described in the previous section, an exercise can be executed in many different ways. This allows for an automatic adaptation of exercises according to user performances, and according to settings specified by the therapist. The adaptation strategies and the therapist adaptation parameters are described above.

C. Conclusion

The described system provides several key improvements in comparison to other systems, as listed below.

1) It allows therapists to achieve the ability to create therapy exercises and exercise programs for individual patients. Therapists are able to create their own exercises by recording their own motions.

2) It provides therapists with the ability to log exercise performance with new metrics for monitoring compliance with a prescribed exercise therapy. Different motion characteristics can be logged and analyzed. The following key parameters were identified as key for achieving visualization solutions for analysis: a) speed of the hand, b) distance between the hand and the target location of the hand during an exercise, c) precise joint angle information, and d) analysis tools for inspecting all possible aspects of the shoulder motion, given the importance and focus on shoulder rehabilitation. The described on-line visual helpers and the shoulder range of motion frequency map represent our novel specific solutions. Trajectory trails provide visual information of the speed of the end-effector (longer trails mean high speed, short trails low speed), distance arrows, and angle display provide real-time or off-line feedback for motion analysis. Therapists can select any of the visualization features to be color-coded automatically, where green colors mean angles, distances and/or speeds performed within expected ranges, and red means not compliant enough according to a given accepted range. The color-coded option is further explained as follows:

2.1) For the target hand velocity of the patient, an acceptable range can be defined manually by providing minimum and maximum values in terms of how much slower and faster (in percentage) the performed motion can be with respect to the demonstrated exercise. Given the information, when the motion of the patient passes these limits, the trajectory trails will gradually change color in the hue space from green to red.

2.2) Similarly, the therapist can specify minimum and maximum values defining acceptance ranges for compliance of the hand position when following exercises. For example, if the patient's hand gets too far away from the target, the distance arrow gradually turns into red.

2.3) For the display of angles, when a patient's joint angle moves more than a given angle threshold, the angle is then displayed. If a minimum and maximum angle limit is specified, the display of the angle gradually turns into red when outside of the range.

3) Integrated visualization of shoulder ROM and upper-arm orientation frequency map. Unlike current state-of-art and traditional listing of individual shoulder joint angles, or use of reachable workspace as an overall global assessment, we have developed a novel algorithm and process to detect upper arm motion, correlated with temporal domain and frequency localization count, and we display the output in a “heat map” analysis of the shoulder joint of intuitive visualization. The clinical utility of such an analysis and visualization scheme is that it can discern areas of missing movement (range of motion) easily, 3D graphically, and dynamically. The integration of a color-coded frequency map represents a novel tool for visualizing the areas within the ROM that were visited more often during an exercise. For example, in our current prototype version, red areas represent orientations (and locations) that were visited often, green areas represent low number of orientations, and no color represents regions not visited. The boundary of the color-coded region represents the boundary of the observed ROM, while the colors inside the map represent regions that were preferred or avoided. Such a map gives instant history visualization of the shoulder rotation, and allows quick inspection of compliance to asked exercises, and identification of disturbance and regions possibly avoided due to pain.

4) Adaptive Delivery: We have also developed strategies for therapist-customized adaptive exercise delivery. This allows the therapist to customize how exercises should be autonomously adapted to the limitations and improvements of the patients automatically during delivery of a therapy program. In the provided software solution, exercise motions are executed by a virtual character to the patient to find out what could happen at home with no other supervision. The therapist can specify different types of autonomous adaptations during motion delivery. Adaptation occurs by automatically adapting the speed, amplitude, and hold and waiting times according to how well the user is able to follow the delivered exercises.

Embodiments of the present invention may be described with reference to flowchart illustrations of methods and systems according to embodiments of the invention, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula (e), or computational depiction(s).

From the discussion above it will be appreciated that the invention can be embodied in various ways, including but not limited to the following:

1. A real-time adaptive virtual therapy and rehabilitation system, comprising: (a) a computer; (b) a sensor operably connected to the computer and configured for sensing one or more users' motion; and (c) programming in a non-transitory computer readable medium and executable on the computer for performing steps comprising: (i) acquiring and storing one or more discrete motions of a first user, said motions corresponding to an exercise; (ii) mapping the acquired one or more discrete motions of the first user as a first avatar comprising a virtual representation of one or more anatomical features of the first user corresponding to said exercise; (iii) acquiring and storing one or more discrete motions of a second user, said motions corresponding to said exercise; (iv) mapping the acquired one or more discrete motions of the second user as a second avatar comprising a virtual representation of one or more anatomical features of the second user corresponding to said exercise; and (v) comparing motion of the second avatar with respect to the second avatar.

2. A system as in any of the previous embodiments, wherein comparing the motion of the second avatar with respect to the second avatar comprises displaying the second avatar overlapped with the first avatar.

3. A system as in any of the previous embodiments, wherein comparing the motion of the second avatar with respect to the second avatar comprises providing visual feedback of the motion of the second avatar.

4. A system as in any of the previous embodiments, wherein providing visual feedback comprises displaying a trajectory trail of at least one of the one or more anatomical features, said trajectory trail comprising a plurality of locations of an anatomical feature over time.

5. A system as in any of the previous embodiments, wherein providing visual feedback comprises displaying an angle measurement corresponding to a joint relating to the one or more anatomical features.

6. A system as in any of the previous embodiments, wherein providing visual feedback comprises displaying a distance measurement between an anatomical feature of the first avatar and an anatomical feature of the second avatar.

7. A system as in any of the previous embodiments, wherein providing visual feedback comprises displaying a range of motion density map, said density map comprising data relating to the frequency of an anatomical feature passing over a series of points in space over a period of time.

8. A system as in any of the previous embodiments, wherein mapping the acquired one or more discrete motions comprises: generating a single character hierarchical skeleton representation corresponding to said first avatar; and storing said one or more discrete motions in memory as a time-series Mᵢ, iε{1, . . . , n}, where each frame Mᵢ is a vector with all joint angles defining one posture of the skeleton representation.

9. A system as in any of the previous embodiments, wherein said programming further performs steps comprising, automatically analyzing the skeleton representation, and determining if the exercise can be parameterized based on analysis of the skeleton representation.

10. A system as in any of the previous embodiments, wherein determining if the exercise can be parameterized comprises: automatic detection of a first and second apices corresponding to points of maximum amplitude that are at intersection points between initial and return phases of the exercise; and determining that the exercise can be parameterized if initial and return phases of the exercise can be segmented.

11. A system as in any of the previous embodiments, wherein said programming further performs steps comprising, performing a run-time motion re-parameterization algorithm to change a motion characteristic of the exercise motion in real-time according to new parameters.

12. A system as in any of the previous embodiments, wherein performing a run-time motion re-parameterization algorithm comprises: segmenting the exercise into at least an initial phase and a return phase; and re-parameterizing an amplitude characteristic with respect to the initial or return phase of the exercise.

13. A system as in any of the previous embodiments, wherein performing a run-time motion re-parameterization algorithm comprises: segmenting the exercise into at least an initial phase and a return phase; and re-parameterizing a velocity characteristic with respect to the initial or return phase of the exercise.

14. A system as in any of the previous embodiments, wherein performing a run-time motion re-parameterization algorithm comprises: segmenting the exercise into at least an initial phase and a return phase; and re-parameterizing a hold time characteristic with respect to the initial and return phase of the exercise.

15. A system as in any of the previous embodiments, the wherein said programming further performs steps comprising: (vi) providing a graphical user interface for the first user to select and group previously acquired exercises from the library of exercises and to create a therapy program for a patient; and (vii) providing a set of automatic exercise delivery adaptation strategies for automatically adapting parameterized exercises to a therapy program.

16. A method for real-time adaptive virtual therapy and rehabilitation, comprising: acquiring and storing one or more discrete motions of a first user, said motions corresponding to an exercise; mapping the acquired one or more discrete motions of the first user as a first avatar comprising a virtual representation of one or more anatomical features of the first user corresponding to said exercise; acquiring and storing one or more discrete motions of a second user, said motions corresponding to said exercise; mapping the acquired one or more discrete motions of the second user as a second avatar comprising a virtual representation of one or more anatomical features of the second user corresponding to said exercise; and comparing motion of the second avatar with respect to the second avatar and outputting the comparison for evaluation of said exercise by said second user.

17. A method as in any of the previous embodiments, wherein comparing the motion of the second avatar with respect to the second avatar comprises displaying the second avatar overlapped with the first avatar.

18. A method as in any of the previous embodiments, wherein comparing the motion of the second avatar with respect to the second avatar comprises providing visual feedback of the motion of the second avatar.

19. A method as in any of the previous embodiments, wherein providing visual feedback comprises displaying a trajectory trail of at least one of the one or more anatomical features, said trajectory trail comprising a plurality of locations of an anatomical feature over time.

20. A method as in any of the previous embodiments, wherein providing visual feedback comprises displaying an angle measurement corresponding to a joint relating to the one or more anatomical features.

21. A method as in any of the previous embodiments, wherein providing visual feedback comprises displaying a distance measurement between an anatomical feature of the first avatar and an anatomical feature of the second avatar.

22. A method as in any of the previous embodiments, wherein providing visual feedback comprises displaying a range of motion density map, said density map comprising data relating to the frequency of an anatomical feature passing over a series of points in space over a period of time.

23. A method as in any of the previous embodiments, wherein density map is color coated to reflect varying colors corresponding to varying frequency values.

24. A method as in any of the previous embodiments, wherein mapping the acquired one or more discrete motions comprises: generating a single character hierarchical skeleton representation corresponding to said first avatar; and storing said one or more discrete motions in memory as a time-series Mᵢ, iε{1, . . . , n}, where each frame M is a vector with all joint angles defining one posture of the skeleton representation.

25. A method as in any of the previous embodiments, the method further comprising: automatically analyzing the skeleton representation, and determining if the exercise can be parameterized based on analysis of the skeleton representation.

26. A method as in any of the previous embodiments, wherein determining if the exercise can be parameterized comprises: automatic detection of a first and second apices corresponding to points of maximum amplitude that are at intersection points between initial and return phases of the exercise; and determining that the exercise can be parameterized if initial and return phases of the exercise can be segmented.

27. A method as in any of the previous embodiments, the method further comprising: performing a run-time motion re-parameterization algorithm to change a motion characteristic of the exercise motion in real-time according to new parameters.

28. A method as in any of the previous embodiments, wherein performing a run-time motion re-parameterization algorithm comprises: segmenting the exercise into at least an initial phase and a return phase; and re-parameterizing an amplitude characteristic with respect to the initial or return phase of the exercise.

29. A method as in any of the previous embodiments, wherein performing a run-time motion re-parameterization algorithm comprises: segmenting the exercise into at least an initial phase and a return phase; and re-parameterizing a velocity characteristic with respect to the initial or return phase of the exercise.

30. A method as in any of the previous embodiments, wherein performing a run-time motion re-parameterization algorithm comprises: segmenting the exercise into at least an initial phase and a return phase; and re-parameterizing a hold time characteristic with respect to the initial and return phase of the exercise.

31. A method as in any of the previous embodiments, the method further comprising: providing a graphical user interface for the first user to select and group previously acquired exercises from the library of exercises and to create a therapy program for a patient; and providing a set of automatic exercise delivery adaptation strategies for automatically adapting parameterized exercises to a therapy program.

32. A real-time adaptive therapy and rehabilitation system using virtual reality, including any of the previous embodiments and: (a) a computer having memory; (b) a sensor operably connected to the computer and configured for sensing a user's motion; and (c) programming executable on the computer in the form of application software configured for performing one or more operations comprising: (i) acquiring and storing discrete motions of said person, said motions corresponding to an exercise; (ii) mapping each motion acquired to a single character hierarchical skeleton representation; (iii) storing said acquired motions in the computer memory for re-play and in the computer's disk for storage as a time-series Mᵢ, iε{1, . . . , n}, where each frame Mᵢ is a vector with all joint angles defining one posture of the character representation; (iv) providing for the user to edit, save, and load any discrete motion captured or stored in a library of exercises; (v) providing for the user to select and group previously acquired exercises from the library of exercises and to create a therapy program for a patient; (vi) automatically analyzing a captured exercise or an exercise loaded from the library of exercises, and determining if the exercise can be parameterized; (vii) if the exercise can be parameterized, performing a run-time motion re-parameterization algorithm to adapt/change the exercise motion in real-time according to specified parameters; (viii) providing a set of automatic exercise delivery adaptation strategies for automatically adapting parameterized exercises to a therapy program; (ix) providing data analysis and monitoring tools for recording and logging all monitored parameters during performance of exercises by a patient; (x) providing for communication with other instances of the system running remotely in another computer, allowing the user to connect from one system instance running at a location of the user to another system running at a location of a patient or therapist.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” Any element in a claim that does not explicitly state “means for” performing a specified function, is not to be interpreted as a “means” or “step” clause as specified in 35 USC §112, sixth paragraph. In particular, the use of “step of” in the claims herein is not intended to invoke the provisions of 35 USC §112, sixth paragraph.

What is claimed is:

1. A real-time adaptive virtual therapy and rehabilitation system, comprising:
(a) a computer;
(b) a sensor operably connected to the computer and configured for sensing one or more users' motion; and
(c) programming in a non-transitory computer readable medium and executable on the computer for performing steps comprising:
(i) acquiring and storing one or more discrete motions of a first user, said motions corresponding to an exercise;
(ii) mapping the acquired one or more discrete motions of the first user as a first avatar comprising a virtual representation of one or more anatomical features of the first user corresponding to said exercise;
(iii) acquiring and storing one or more discrete motions of a second user, said motions corresponding to said exercise;
(iv) mapping the acquired one or more discrete motions of the second user as a second avatar comprising a virtual representation of one or more anatomical features of the second user corresponding to said exercise; and
(v) comparing motion of the second avatar with respect to the second avatar.

2. A system as recited in claim 1, wherein comparing the motion of the second avatar with respect to the second avatar comprises displaying the second avatar overlapped with the first avatar.

3. A system as recited in claim 1, wherein comparing the motion of the second avatar with respect to the second avatar comprises providing visual feedback of the motion of the second avatar.

4. A system as recited in claim 3, wherein providing visual feedback comprises displaying a trajectory trail of at least one of the one or more anatomical features, said trajectory trail comprising a plurality of locations of an anatomical feature over time.

5. A system as recited in claim 3, wherein providing visual feedback comprises displaying an angle measurement corresponding to a joint relating to the one or more anatomical features.

6. A system as recited in claim 3, wherein providing visual feedback comprises displaying a distance measurement between an anatomical feature of the first avatar and an anatomical feature of the second avatar.

7. A system as recited in claim 3, wherein providing visual feedback comprises displaying a range of motion density map, said density map comprising data relating to the frequency of an anatomical feature passing over a series of points in space over a period of time.

8. A system as recited in claim 1, wherein mapping the acquired one or more discrete motions comprises:
generating a single character hierarchical skeleton representation corresponding to said first avatar; and
storing said one or more discrete motions in memory as a time-series Mᵢ, iε{1, . . . , n}, where each frame Mᵢ is a vector with all joint angles defining one posture of the skeleton representation.

9. A system as recited in claim 8, wherein said programming further performs steps comprising, automatically analyzing the skeleton representation, and determining if the exercise can be parameterized based on analysis of the skeleton representation.

10. A system as recited in claim 9, wherein determining if the exercise can be parameterized comprises:
automatic detection of a first and second apices corresponding to points of maximum amplitude that are at intersection points between initial and return phases of the exercise; and
determining that the exercise can be parameterized if initial and return phases of the exercise can be segmented.

11. A system as recited in claim 10, wherein said programming further performs steps comprising, performing a run-time motion re-parameterization algorithm to change a motion characteristic of the exercise motion in real-time according to new parameters.

12. A system as recited in claim 10, wherein performing a run-time motion re-parameterization algorithm comprises:
segmenting the exercise into at least an initial phase and a return phase; and
re-parameterizing an amplitude characteristic with respect to the initial or return phase of the exercise.

13. A system as recited in claim 10, wherein performing a run-time motion re-parameterization algorithm comprises:
segmenting the exercise into at least an initial phase and a return phase; and
re-parameterizing a velocity characteristic with respect to the initial or return phase of the exercise.

14. A system as recited in claim 10, wherein performing a run-time motion re-parameterization algorithm comprises:
segmenting the exercise into at least an initial phase and a return phase; and
re-parameterizing a hold time characteristic with respect to the initial and return phase of the exercise.

15. A system as recited in claim 1, the wherein said programming further performs steps comprising:
(vi) providing a graphical user interface for the first user to select and group previously acquired exercises from the library of exercises and to create a therapy program for a patient; and
(vii) providing a set of automatic exercise delivery adaptation strategies for automatically adapting parameterized exercises to a therapy program.

16. A method for real-time adaptive virtual therapy and rehabilitation, comprising:
acquiring and storing one or more discrete motions of a first user, said motions corresponding to an exercise;
mapping the acquired one or more discrete motions of the first user as a first avatar comprising a virtual representation of one or more anatomical features of the first user corresponding to said exercise;
acquiring and storing one or more discrete motions of a second user, said motions corresponding to said exercise;
mapping the acquired one or more discrete motions of the second user as a second avatar comprising a virtual representation of one or more anatomical features of the second user corresponding to said exercise; and
comparing motion of the second avatar with respect to the second avatar and outputting the comparison for evaluation of said exercise by said second user.

17. A method as recited in claim 16, wherein comparing the motion of the second avatar with respect to the second avatar comprises displaying the second avatar overlapped with the first avatar.

18. A method as recited in claim 16, wherein comparing the motion of the second avatar with respect to the second avatar comprises providing visual feedback of the motion of the second avatar.

19. A method as recited in claim 18, wherein providing visual feedback comprises displaying a trajectory trail of at least one of the one or more anatomical features, said trajectory trail comprising a plurality of locations of an anatomical feature over time.

20. A method as recited in claim 19, wherein providing visual feedback comprises displaying an angle measurement corresponding to a joint relating to the one or more anatomical features.

21. A method as recited in claim 19, wherein providing visual feedback comprises displaying a distance measurement between an anatomical feature of the first avatar and an anatomical feature of the second avatar.

22. A method as recited in claim 19, wherein providing visual feedback comprises displaying a range of motion density map, said density map comprising data relating to the frequency of an anatomical feature passing over a series of points in space over a period of time.

23. A method as recited in claim 22, wherein density map is color coated to reflect varying colors corresponding to varying frequency values.

24. A method as recited in claim 16, wherein mapping the acquired one or more discrete motions comprises:
generating a single character hierarchical skeleton representation corresponding to said first avatar; and
storing said one or more discrete motions in memory as a time-series Mᵢ, iε{1, . . . , n}, where each frame Mᵢ is a vector with all joint angles defining one posture of the skeleton representation.

25. A method as recited in claim 24, the method further comprising:
automatically analyzing the skeleton representation, and determining if the exercise can be parameterized based on analysis of the skeleton representation.

26. A method as recited in claim 25, wherein determining if the exercise can be parameterized comprises:
automatic detection of a first and second apices corresponding to points of maximum amplitude that are at intersection points between initial and return phases of the exercise; and
determining that the exercise can be parameterized if initial and return phases of the exercise can be segmented.

27. A method as recited in claim 25, the method further comprising:
performing a run-time motion re-parameterization algorithm to change a motion characteristic of the exercise motion in real-time according to new parameters.

28. A method as recited in claim 25, wherein performing a run-time motion re-parameterization algorithm comprises:
segmenting the exercise into at least an initial phase and a return phase; and
re-parameterizing an amplitude characteristic with respect to the initial or return phase of the exercise.

29. A method as recited in claim 25, wherein performing a run-time motion re-parameterization algorithm comprises:
segmenting the exercise into at least an initial phase and a return phase; and
re-parameterizing a velocity characteristic with respect to the initial or return phase of the exercise.

30. A method as recited in claim 25, wherein performing a run-time motion re-parameterization algorithm comprises:
segmenting the exercise into at least an initial phase and a return phase; and
re-parameterizing a hold time characteristic with respect to the initial and return phase of the exercise.

31. A method as recited in claim 16, the method further comprising:
providing a graphical user interface for the first user to select and group previously acquired exercises from the library of exercises and to create a therapy program for a patient; and
providing a set of automatic exercise delivery adaptation strategies for automatically adapting parameterized exercises to a therapy program.
